(19) United States
(12) Patent Application Publication
(10) Pub. No.: US 2003/0046169 A1
(43) Pub. Date: Mar. 6, 2003

(54) Procurement and management of professional services

(76) Inventors: Richard Fraser, Edmonton (CA); Laine Woollard, Edmonton (CA); Grant G. Brown, Winnipeg (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 09/682,439

(22) Filed: Sep. 4, 2001

(51) Int. Cl. G06F 17/60

(52) U.S. Cl. 705/26

(57) ABSTRACT

A computer implemented method of procuring and managing professional services includes the steps of prompting a service provider to complete an online service order which identifies estimated time to deliver the services, the estimated cost of the services and the predicted results. The client or customer then stores the estimates in a computer memory. When complete, the service provider completes a completion order which is compared to the service order to calculate the variance or otherwise compare the estimated information to the actual results. Database tools may be used to analyze the data collected.

### BACKGROUND OF INVENTION

The invention relates to the methods to procure and manage professional services such as accounting, consulting, healthcare, legal and management services.

Consumers of professional services judge those services based on the three primary factors of time, cost and results. Currently most consumers of professional services play a passive role. This is especially so in relation to service providers such as lawyers. Clients often, but not always, ask for estimates of time, cost for legal services and the likelihood of certain outcomes or results. The lawyer will perform the service and render an account, which may be based on the amount of time spent on the matter multiplied by an hourly rate set by the lawyer. Alternative billing arrangements do exist such as flat fee retainers and contingency fee arrangements but are not suitable for most legal matters. However, in most cases, the lawyer sets a fee when the service is complete based on their hourly rate, the value of the service to the client, and a myriad number of other factors that are considered in arriving at a “fair” fee. The result achieved may or may not be a factor. The lawyer may or may not consider the original estimate provided to the client. It is a very paternalistic system.

Typically, neither the lawyer nor the client possesses a documented comparison between estimated and actual time, cost and results. There is little aggregated data to analyze. There is little shared ownership of the accountabilities of time, cost and results. In fact it is often the client's wish not to have any accountability for these factors. This is especially true in large organizations. This paradigm works well to retain a status quo in which the client is not responsible and the lawyer has a captive client.

Prior art computer-implemented methods of procuring professional services focus on “bid” or “auction” type processes which are conducted over a computer network such as the Internet. For example, in PCT Patent Application PCT/US00/13672 (WO 00/72207 A1), a computer system and method is disclosed whereby a user can browse a network of service providers and select providers from which the user would like to receive proposals. The user then prepares a request for proposal (RFP) that is available to each selected service provider, who then respond. In PCT Patent Application PCT/US00/13672 (WO 00/72207 A1), a computer system and method for procuring legal services is disclosed. In this disclosure, the user makes use of a bid process whereby information about a legal matter is posted on a network resource. Bids are accepted from network users with respect to the legal matter. The network users use web browser applications. It is stated that the methods provide an efficient mechanism for promoting price competition.

These methods may allow a client to obtain the lowest price possible for a discrete and well-defined piece of legal work, but do not fit well within established lawyer-client relationships. Very often, a client chooses to use a particular law firm because the client values the skill, experience and responsiveness of the firm and does not wish to experiment with other lawyers or law firms solely on the basis of cost. At the same time, it would be useful for both the client and the lawyer within that established relationship to exchange and accumulate data regarding estimates and bills to establish and build upon the existing relationship.

The delivery of healthcare is a similarly paternalistic system. Healthcare services are typically performed on a fee-for-service basis whereby healthcare providers perform healthcare procedures and render a bill to a government authority in the case of state-funded systems or an insurance company in the case of private systems. The patient is of course most focused on time and results, while the funding agency is naturally greatly concerned with cost. At present, there is no organized system which permits the factors of time, cost and results to be effectively tracked in an integrated manner in order to manage health care delivery and gauge effectiveness and cost efficiency.

It is an object of the invention to provide a computer-implemented method of procuring and managing professional services, such as legal services or healthcare delivery, which method mitigates the disadvantages of the prior art.

### SUMMARY OF INVENTION

The present invention is directed to computer-implemented methods and apparatuses intended to maintain and enhance the provision of client/consumer/patient focused, appropriate, accessible and affordable services by service providers to clients, customers or patients. The methods of the present invention assist customers to become informed consumers of services, measure services (outputs and inputs) and develop an institutional memory that does not reside solely with the service provider.

Accordingly, in one aspect, the invention comprises a method for procuring and managing professional services by an organization via a computer network, said method comprising: (a) providing a computer controlled by the organization which may communicate with a service provider computer over a computer network; (b) prompting a service provider to complete a service order comprising at least the following information to the organization: i. a file identifier; ii. a description of the services to be provided; and iii. estimated cost; (c) receiving the service order for approval or disapproval; and (d) notifying the service provider of the approval or disapproval.

The method may further comprise the steps of: (a) storing the service order in a memory accessible to the organization; (b) upon completion of the professional services, prompting the service provider to enter a completion order comprising at least the following information: i. the file identifier; and ii. actual cost; (c) receiving the completion order and adding it to the service order; and (d) providing means to compare the estimated cost of the service order to the actual cost of the completion order.

The service order may include some or all of the following information: (e) activity code matched to a category of type of service; (f) identity of individual service provider; (g) desired result; (h) estimated completion date; and (i) estimated time to complete.

The method may further comprise the steps of: (j) storing the service order in a memory accessible to the organization; (k) upon completion of the professional services, prompting the service provider to enter a completion order comprising at least the following information: i. the file identifier; ii. the actual cost; iii. actual result obtained; iv. actual completion date; and v. actual time to complete; (l) receiving the completion order and adding it to the service order; and providing means to compare the information in the service order to the corresponding information in the completion order.

### BRIEF DESCRIPTION OF DRAWINGS

The invention will now be described by way of an exemplary embodiment with reference to the accompanying simplified, diagrammatic, not-to-scale drawings. In the drawings:

FIG. 1 is a block diagram illustrating a system for procuring and managing professional services conducted via a computer network.

FIG. 2 is a block diagram illustrating a computer configured to implement a method of the present invention.

FIG. 3 is a diagram of a web page menu as seen by a service provider.

FIG. 4 is a diagram of a web page service order.

FIG. 5 is a diagram of a web page menu as seen by a client contact.

FIG. 6 is a diagram of a web page generated to approve or disapprove of a service order.

FIG. 7 is a diagram of a web page change order.

FIG. 8 is a flowchart of the process from the point of view of the service provider.

FIG. 9 is a flowchart of the process from the point of view of the client contact.

### DETAILED DESCRIPTION

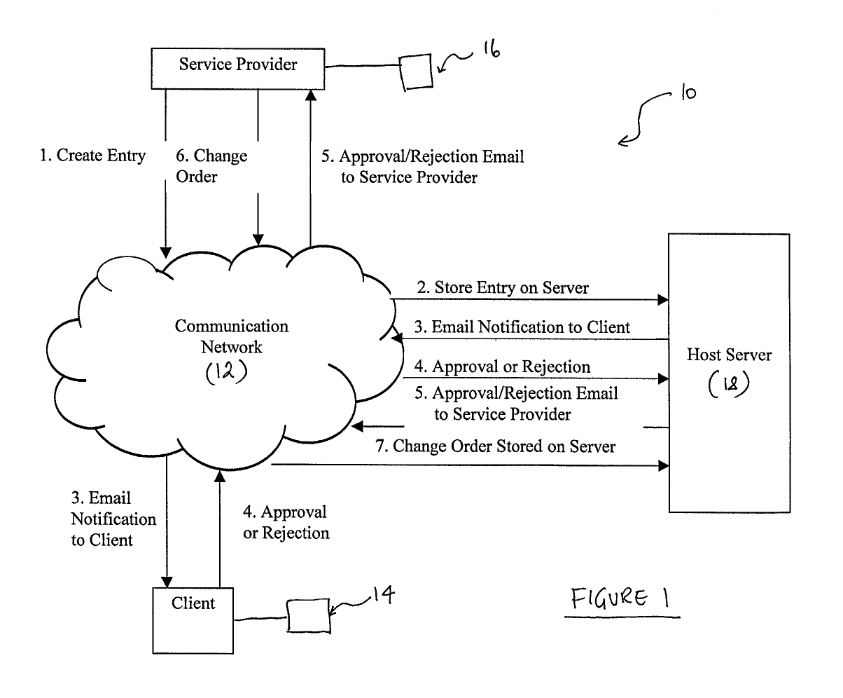

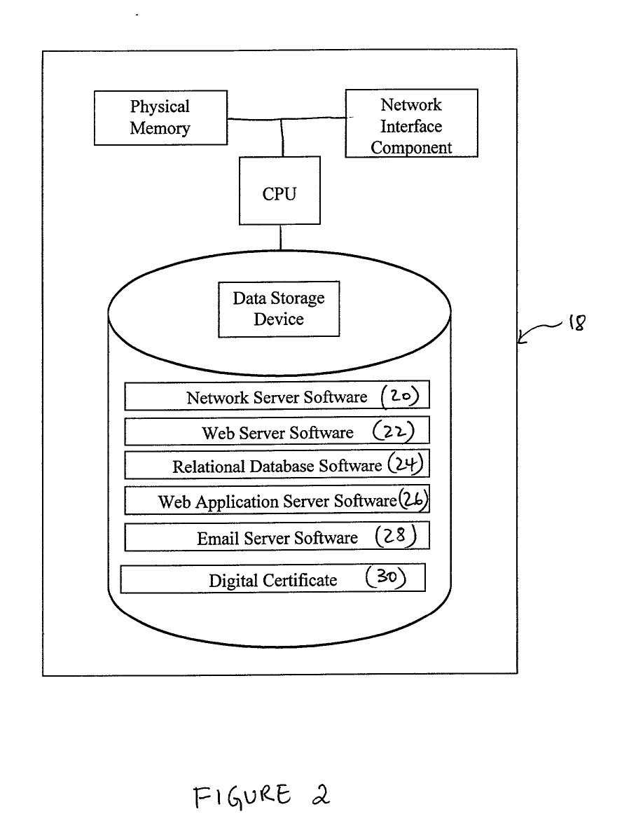

FIG. 1 is a block diagram illustrating a system (10) for facilitating procurement of legal services via a global computer communication network (12), such as the world wide web. System (10) can be used to practice methods for facilitating procurement of legal services via a global computer network. As shown in FIG. 1, system (10) may include a number of user computers (14, 16) and a host server (18) operating network server software (20), web server software (22), relational database software (24), web application server software (26), an email server software (28) and a digital certificate (30) for security purposes. User computers (14, 16) and server (18) are connected via world wide web (12). The server (18) administers a procurement and management process for professional services, facilitating interaction between clients and professional service providers. In the embodiment described, the services providers are lawyers or law firms providing legal services, although the invention may be equally applied to service providers such as accountants, consultants, management professionals, or healthcare professionals. The host server (18) is shown schematically in FIG. 2 and may take the form of a single web server or multiple web servers, and may execute server page scripts. The scripts can be written as Active Server Pages (ASP) or in other server based scripting languages such as CGI. ASP is bundled with the Microsoft Internet Information Server. ASP code is mixed within HTML in a web page and does not need to be compiled separately. Accordingly, ASP commands can be simply added to pages executed by web server (22) to modify its operation. ASP is especially useful in building database driven websites. In particular, ASP can allow browser users to manipulate databases, e.g., view, edit, and manage, from any browser using HTUI and active data objects, and allow HTML web pages to generate database updates.

In operation, web server software (22) interacts with database server (24) to provide network users with access to information contained in a relational database. Web server software (22) assembles the necessary content for web pages requested by users, and accepts information from users for addition to database. Database server software (24) simply requires an OLEDB or ODBC driver for interaction with web server (22). In response to queries from web server 22, database server 24 locates appropriate records within database 26. An access profile database 28 defines access profiles that limit the scope of information available to particular network users.

A firewall preferably may be provided as a security measure. The firewall separates database server 24 and web server 22 to avoid unauthorized intrusions into the client information. Due to its nature as a repository of information concerning legal matters, the security and confidentiality of database is a serious concern. To promote increased security and confidentiality of client information, web pages generated by web server 22 can be communicated to network users using public key encryption mechanisms such as SSL. Other security measures, such as the use of login accounts for network users, can provide added benefits. As well, the application may be made to time out after a set period of time (10 15 minutes) of inactivity to increase security and to lighten the load on the server.

Computers (14, 16) may take the form of personal computers, Macintosh computers, workstations, handheld computing devices, or the like, equipped with telecommunications services for access to network (12). Computers (14, 16) can be connected to network (12) directly or via an internet service provider, and communicate using a network protocol such as TCP/IP. In most cases, the service provider computer (16) is part of a local area network which is connected to the network (12). Similarly, the client computer (14) may be part of a local area network which is connected to the network. Each computer executes a viewing application such as a web browser to access resources residing on other computers attached to network (12). In particular, web browser permits a network user to view HTML web pages generated by web server (22).

In system (10), network users include an organization (client) which makes use of legal services and the law firm legal service provider. The number of network users in system (10) can be virtually unlimited, although system operation may be subject to bandwidth limitations of server (18) and network (12). The legal client situated at computer (14) retrieves information from the web server (18) via network (12), and view information pertaining to legal matters managed by the within process. The law firms, individual attorneys, or their agents, view legal matter information provided by web server (18) and submit service orders for delivery of legal services with respect to particular legal matters. In the figures, such service orders are depicted as legal service orders or LSO's.

The system and method of the present invention is intended to operate within a existing solicitor-client relationship between a law firm and the organization, although the claims are not necessarily limited to that situation. The process begins by a responsible individual within the client organization informing a lawyer at the law firm of a new legal matter and provides a description of the matter. This may be done by a phone conversation, email or any other form of communication. The lawyer then connects to the web server (18), preferably through a secure login process, and selects an appropriate web page. The lawyer menu may be as shown in FIG. 3, where the lawyer may choose to enter a new service order, modify an existing service order or complete an existing order. Web server (18) then provides one or more interactive web pages requesting user input. One such web page is the service order (LSO), which may be as shown in FIG. 4. The following information may be entered into the service order, however, there is no limitation as to the types of information that may prove useful to record and review in managing the relationship between organization and law firm.

The lawyer may choose to enter a general or specific order. In general, most individual legal matters will be specific. The client contact (individual responsible for the matter) may then be entered or chosen from a drop-down list as is well-known in the art. The legal contact (lawyer) may also be entered or chosen from a list. If a third party, either adverse or allied, is involved, the third party may be entered or chosen from list. A matter identifier may be entered or chosen from a list. In one embodiment, the client may create a new matter with a new identifier, prior to contacting the lawyer. In that case, the system may have included the new identifier in a drop-down list to be chosen by the lawyer. If desired, a number of different categories of legal services may be provided and chosen when completing the services order. The desired result may be entered into another field. The desired result may be succinctly stated, such as “negotiation and execution of a consulting agreement” or “preparation and filing of a patent application”. The lawyer may then enter the following estimates: time to complete, legal fees and disbursements. Once completed and submitted, the system may integrate with the email server to send an email to the client contact, notifying the contact that a service order has been submitted by the lawyer and requires approval. The client may be presented a series of web pages which appears like those diagrammed in FIGS. 5 and 6. The client can indicate to the system that the order is approved, in which case an email may be sent to the lawyer notifying the lawyer of the approval to proceed. The information in the service order is stored in the database.

If the service is disapproved, the comments entered by the client contact where provided in FIG. 6 may then be incorporated automatically into an email which is sent to the lawyer by the system.

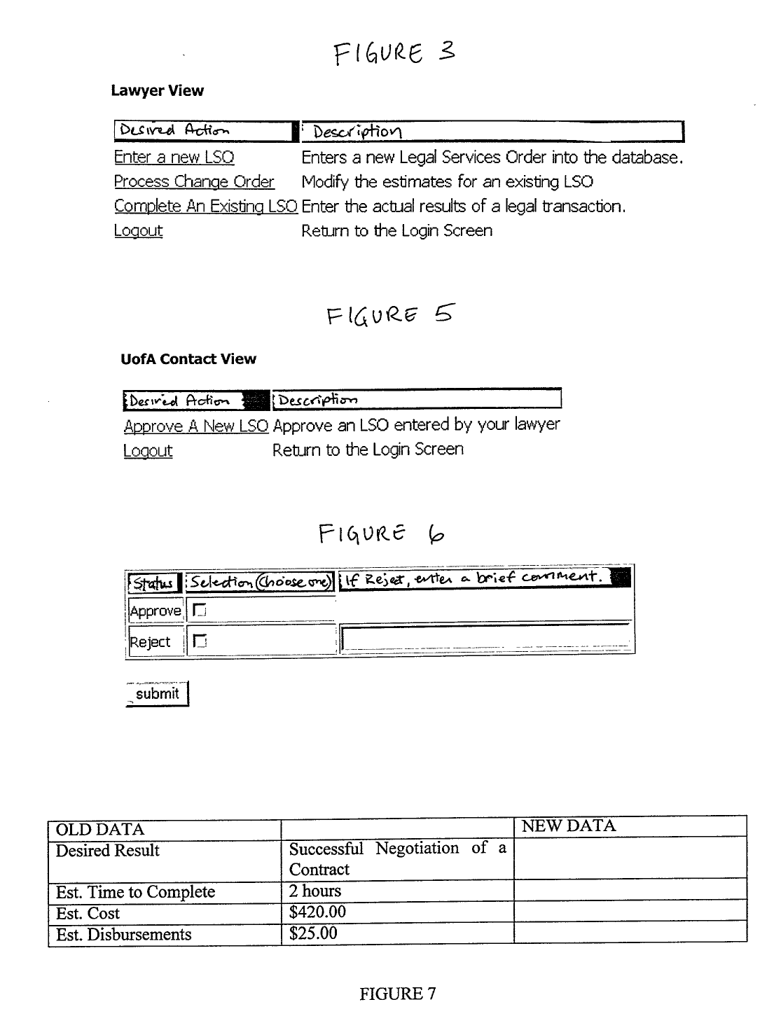

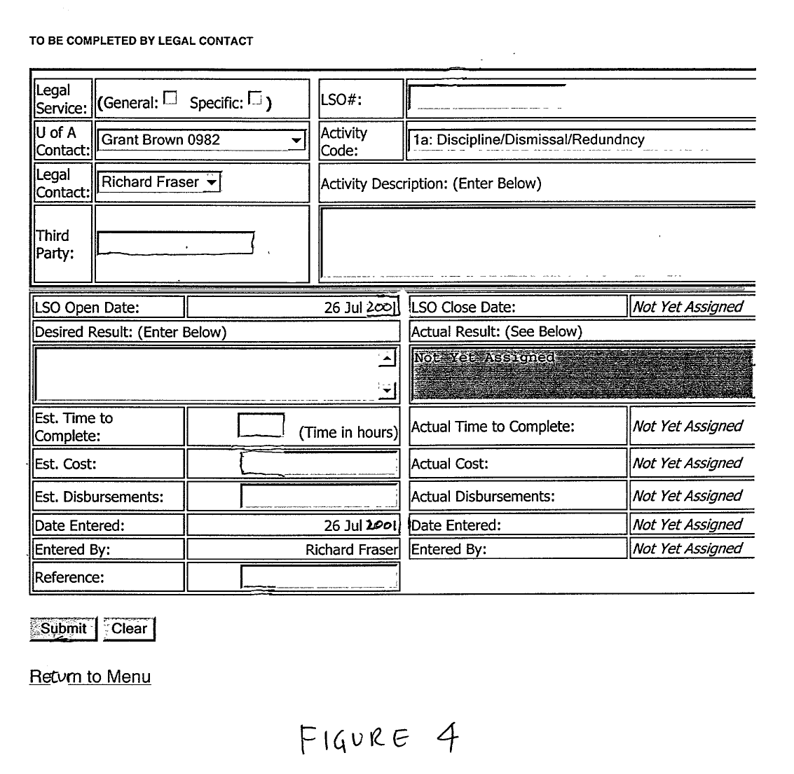

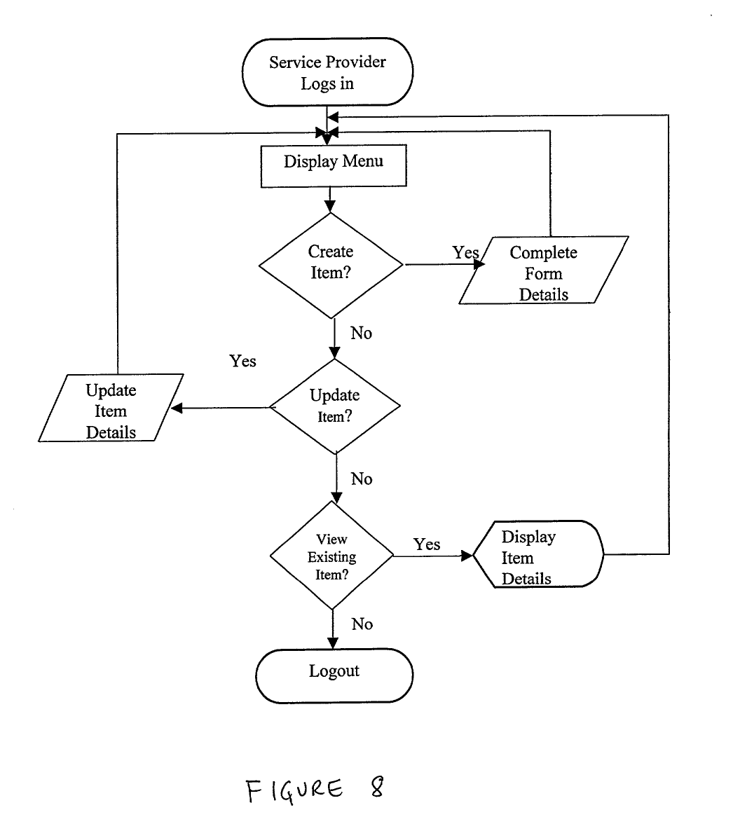

A change order may be accessed and completed by the lawyer, as illustrated in FIG. 7. A change order is appropriate if the lawyer wishes to revise any of the original information in the service order.

Each service order record in database (24) includes information relating to a particular legal matter, identified by a unique identifier.

Upon completion of the legal matter, the lawyer may then enter a completion order which may appear substantially the same as a service order or a change order. Once a completion order has been submitted, that particular legal matter is deemed closed and may be removed from any list of active or pending service orders. Again, the submission of a completion order may result in an email notification to the client contact.

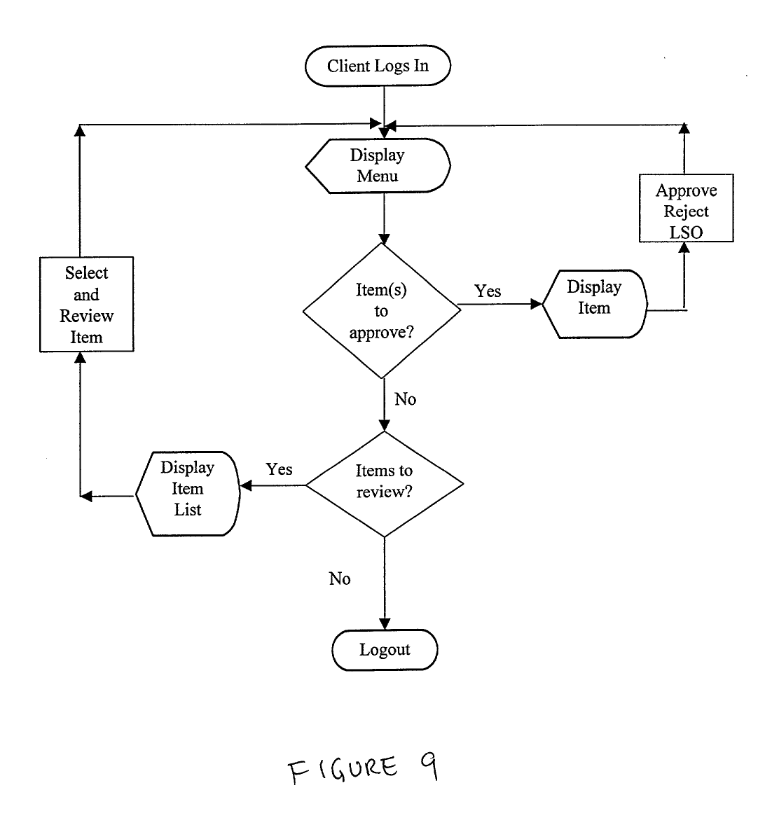

FIG. 8 is a flowchart of the process from the lawyer point of view. When the lawyer first logs in, a display menu offering the choices shown in FIG. 3 is presented. The lawyer may create a service order or update a previous service order. The lawyer may or may not view details of the item created or modified before logging out.

FIG. 9 is a flowchart of the process from the client point of view. Upon logging, the display menu may indicate whether service orders need to be reviewed and approved. A list of service orders or the details of one service order may be displayed in a series of web pages.

As more and more service orders are initiated and completed, the client organization will have more and more data to analyze its relationship(s) with its various outside counsel (or other service providers). Such counsel may be appraised on the variance between estimated and actual costs, time to completion. Such analyses may be compared between law firms, or between individual lawyers within a law firm or between individual lawyers at different law firms. With the capability of modern spreadsheet software, there are many different and useful analyses which can be made with the data that is collected. As one skilled in the art may appreciate, the service order may be customized to capture any information which the client organization and/or the service provider firm deems to be relevant or useful to keep records of and to analyze.

In the context of healthcare, the service provider may be a healthcare provider such as a doctor, a hospital, medical clinic or other licensed healthcare service provider such as a medical testing laboratory, medical imaging clinic, optometrist or physiotherapist and the client may be an authority, private or public, which funds healthcare, acting as the agent of the patient who is receiving the care. The elements of the process described above will apply equally to this context. In one embodiment, the process is initiated by a patient visiting a doctor with an injury or ailment. The doctor may make the diagnosis and discuss the prognosis with the patient, as is the prior art model. The doctor may then complete a medical services order which includes estimates for time, cost and results, preferably in consultation with the patient. The medical services order may then be processed in the same manner as the legal service order described above. The accumulated information gathered by the funding agency would provide valuable insights into health care management, cost efficiency and the effectiveness of healthcare services provided by certain individuals, organizations or regions, or any other categorization which may be relevant.

As will be apparent to those skilled in the art, various modifications, adaptations and variations of the foregoing specific disclosure can be made without departing from the scope of the invention claimed herein.

1. A computer implemented method for procuring and managing professional services by an organization via a computer network, said method comprising:
(a) providing a computer controlled by the organization which may communicate with a service provider computer over a computer network;
i. prompting a service provider to complete a service order comprising at least the following information to the organization:a file identifier;
ii. a description of the services to be provided; and
iii. estimated cost;
(b) receiving the service order for approval or disapproval; and
(c) notifying the service provider of the approval or disapproval.

2. The method of claim 1 further comprising the steps of:
(a) storing the service order in a memory accessible to the organization;
(b) upon completion of the professional services, prompting the service provider to enter a completion order comprising at least the following information:
i. the file identifier; and
ii. actual cost;
(c) receiving the completion order and adding it to the service order; and
(d) providing means to compare the estimated cost of the service order to the actual cost of the completion order.

3. The method of claim 1 wherein the service order further comprises an individual contact within the organization.

4. The method of claim 3 wherein the individual is prompted to review the service order by email notification.

5. The method of claim 1 wherein the service order further comprises one, some or all of the following information:
(a) activity code matched to a category of type of service;
(b) identity of individual service provider;
(c) desired result;
(d) estimated completion date; and
(e) estimated time to complete.

6. The method of claim 5 further comprising the steps of:
(a) storing the service order in a memory accessible to the organization;
(b) upon completion of the professional services, prompting the service provider to enter a completion order comprising at least the following information:
i. the file identifier;
ii. the actual cost;
iii. actual result obtained;
iv. actual completion date; and
v. actual time to complete;
(c) receiving the completion order and adding it to the service order; and
(d) providing means to compare the information in the service order to the corresponding information in the completion order.
